(19) United States
(12) Patent Application Publication
(10) Pub. No.: US 2011/0025593 A1
(43) Pub. Date: Feb. 3, 2011

(54) BACKLIGHT UNIT AND DISPLAY APPARATUS INCLUDING THE SAME

(75) Inventors: Won Do KEE, Pyeongtaek-si (KR); Seung Se KIM, Pyeongtaek-si (KR); Yong Suk KIM, Pyeongtaek-si (KR); Chan Sung JEONG, Pyeongtaek-si (KR)

Correspondence Address: KED & ASSOCIATES, LLP, P.O. Box 8638, Reston, VA, 20195, US

(73) Assignee: LG Electronics Inc., Seoul (KR)

(21) Appl. No.: 12/728,087

(22) Filed: Mar. 19, 2010

Related U.S. Application Data
(60) Provisional application No. 61/230,844, filed on Aug. 3, 2009.

(30) Foreign Application Priority Data
Aug. 2, 2009 (KR) 10-2009-0071111

(51) Int. Cl. G09G 3/36; G02F 1/13357

(52) U.S. Cl. 345/102; 362/97.1; 362/84

(57) ABSTRACT

A backlight unit includes a plurality of light sources emitting light in a direct direction with a predetermined orientation angle, and a light guide panel having a light incident section and a light emitting section. The light incident section has a first surface to receive light emitted from one or more of the light sources in the first direction and the light emitting section is to emit light received from the light incident section in a second direction. In addition, a height of an elevated structure, extending from an upper surface of the light incident section to an upper surface of the light emitting section, is greater than or substantially equal to a height of a distal end of the light emitting section.

### CROSS-REFERENCE TO RELATED APPLICATIONS

The present application claims priority under 35 U.S.C. §119 and 35 U.S.C. §365 to U.S. Provisional Patent Application Ser. No. 61/230,844 filed on Aug. 3, 2009 and Korean Patent Application No. 10-2009-0071111, filed on Aug. 2, 2009, which are hereby incorporated by reference in their entirety.

### BACKGROUND

1. Field

One or more embodiments described herein relate to illumination systems.

2. Background

As our information society develops, needs for diverse forms of display apparatuses are increasing. Accordingly, research has been carried out on various display apparatuses such as liquid crystal display devices (LCDs), plasma display panels (PDPs), electro luminescent displays (ELDs), and vacuum fluorescent displays (VFDs), which have been commercialized.

Of these, an LCD has a liquid crystal panel that includes a liquid crystal layer, a thin film transistor (TFT) substrate, and a color filter substrate facing the TFT substrate with the liquid crystal layer therebetween. Such a liquid crystal panel, having no light source, uses light provided by a backlight unit to display an image.

### BRIEF DESCRIPTION OF THE DRAWINGS

FIG. 1 is a diagram showing one embodiment of a display apparatus.

FIG. 2 is a diagram showing cross-sectional view along line A-A in FIG. 1.

FIG. 3 is a diagram showing one embodiment of a backlight unit which, for example, may be included in the display apparatus of FIG. 1

FIG. 4 is a diagram showing a light guide panel and light sources in FIG. 3.

FIG. 5 is a diagram showing portion C in FIG. 4.

FIG. 6 is a diagram showing a cross-sectional view taken along a first direction of a light guide panel according to one or more embodiments disclosed herein.

FIG. 7 is a diagram showing a cross-sectional view of a backlight unit according to one or more embodiments disclosed herein.

FIG. 8 is a diagram showing a light guide panel which may be included in the backlight unit of FIG. 7.

FIG. 9 shows controlling elements for a display apparatus according to an embodiment.

FIG. 10 shows controlling elements for a back light unit according to an embodiment.

FIG. 11 is a perspective view illustrating a reflecting element and a substrate according to an embodiment.

FIG. 12 is a perspective view illustrating a backlight unit according to an embodiment.

FIG. 13 is a plan view of a rear surface of a bottom cover of FIG. 12.

FIG. 14 is a perspective view of a substrate according to an embodiment.

FIG. 15 is a perspective view of a rear surface of the substrate of FIG. 14.

FIG. 16 is an exploded perspective view of an optical assembly according to an embodiment.

FIG. 17 is a perspective view of two light guide panels that are aligned of FIG. 16.

### DETAILED DESCRIPTION

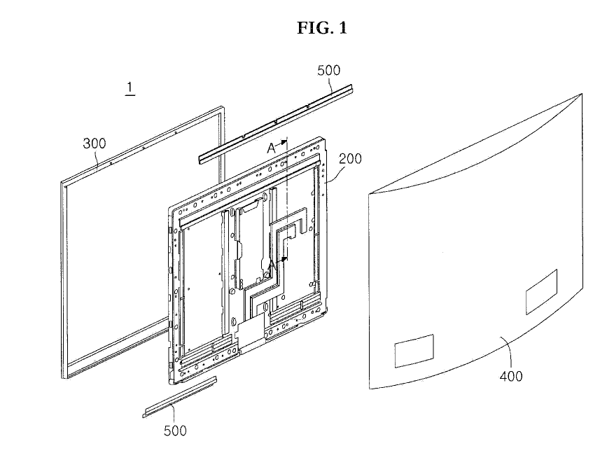

FIG. 1 is an exploded perspective view illustrating a display apparatus 1 according to an embodiment. Referring to FIG. 1, the display apparatus 1 includes a display module 200, a front cover 300 and a back cover 400 that surround the display module 200, and a fixing member 500 for fixing the display module 200 to at least one of the front cover 300 and the back cover 400.

A portion of the fixing member 500 is fixed to the front cover 300 through a coupling member such as a screw, and then, another portion of the fixing member 500 supports the display module 200 with respect to the front cover 300, so that the display module 200 can be fixed with respect to the front cover 300.

Although the fixing member 500 has an elongated plate shape in the current embodiment, the display module 200 may be fixed to the front cover 300 or the back cover 400 through a coupling member without the fixing member 500.

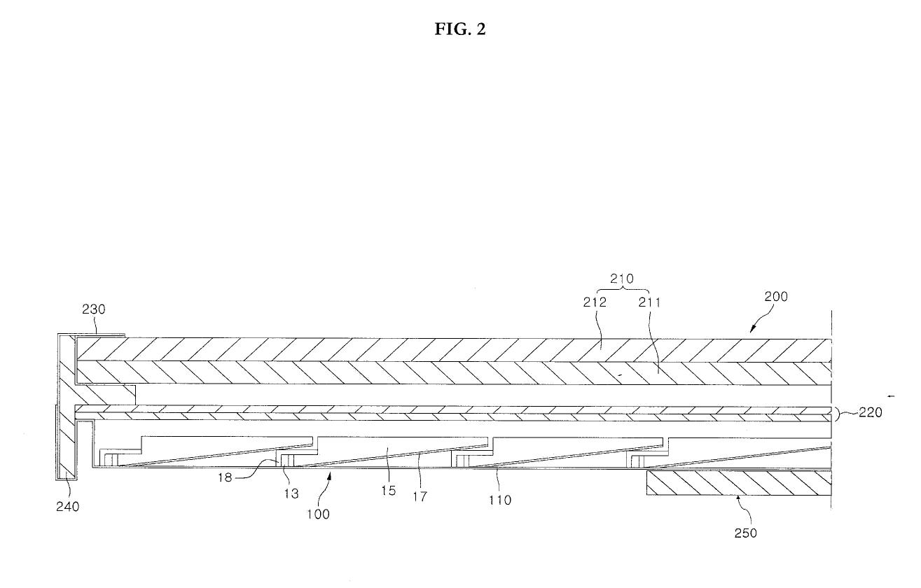

FIG. 2 is a cross-sectional view taken along line A-A of FIG. 1. Referring to FIG. 2, the display module 200 includes a display panel 210 for displaying an image, a backlight unit 100 emitting light to the display panel 210, a bottom cover 110 providing the lower appearance of the display module 200, a panel supporter 240 supporting the display panel 210 from the lower side, a top cover 230 supporting the display panel 210 from the upper side and constituting a border of the display module 200.

The bottom cover 110 may have a box shape with an open upper surface to receive the backlight unit 100. A side of the bottom cover 110 may be fixed to a side of the top cover 230. For example, a coupling member such as a screw may pass through a side surface of the display module 200, that is, through a side where the bottom cover 110 overlaps the top cover 230 to fix the bottom cover 110 and the top cover 230.

A rear surface of bottom cover 110 is provided with at least one circuit 250 to drive display module 200 with a signal transmitted from the outside, e.g. an image signal.

The circuit 250 may be, e.g., a driving circuit of an image display, as a timing controller, a T-con board, or a main printed circuit board (PCB), and fixed to the rear surface of the bottom cover 110 through an adhesive member or a coupling member such as a screw.

For example, the display panel 210 may include a lower substrate 211 and an upper substrate 212 attached to each other with a constant cell gap, and a liquid crystal layer interposed between the lower substrate 211 and the upper substrate 212. The lower substrate 211 is provided with a plurality of gate lines and a plurality of data lines crossing the gate lines. Thin film transistors (TFTs) may be disposed in crossing areas of the gate lines and the data lines.

The upper substrate 212 may be provided with color filters, but the structure of the display panel 210 is not limited thereto. For example, the lower substrate 211 may include color filters as well as TFTs. In addition, the structure of the display panel 210 may be varied according to a method of driving the liquid crystal layer.

Although not shown, an edge of the display panel 210 may be provided with a gate driving printed circuit board (PCB) supplying scan signals to the gate lines, and a data driving PCB supplying data signals to the data lines. One of the upper and lower sides of the display panel 210 may be provided with a polarized light filter (not shown).

An optical sheet 220 may be disposed between the display panel 210 and the backlight unit 100, or the optical sheet 220 may be removed, and thus the present disclosure is not limited thereto. The optical sheet 220 may include at least one of a spread sheet (not shown) and a prism sheet (not shown).

The spread sheet uniformly spreads light emitted from a light guide panel, and the spread light may be collected to the display panel 210 through the prism sheet. The prism sheet including one or more illumination enhancement films and at least one of a horizontal prism sheet and a vertical prism sheet may be selectively provided. The types and number of optical sheets may be varied within the scope of the present disclosure.

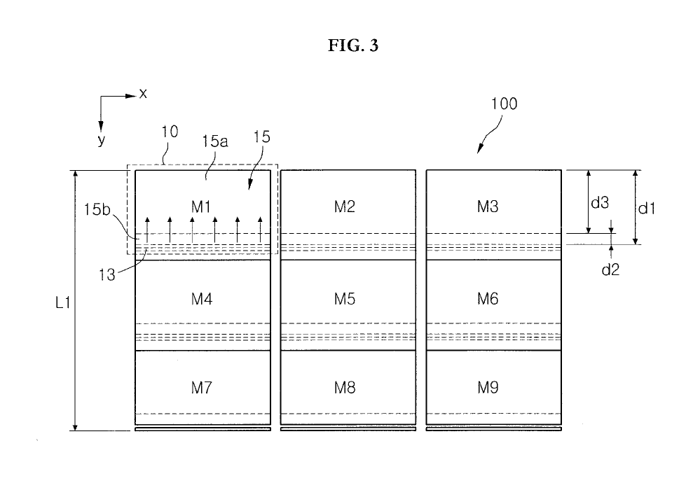

The backlight unit 100 may include a plurality of optical assemblies 10 (refer to FIG. 3), each of which may include a light source 13, a light guide panel 15, and a reflecting member 17, and a fixing bracket 18.

The light source 13 is disposed on a side of the light guide panel 15 to emit light to the side of the light guide panel 15. For example, the light source 13 may include one or more light emitting diodes (LEDs).

The LED may be a side illumination-type LED, and be a color LED emitting at least one of red, blue, and green light, or a white LED. The color LED may include at least one of a red LED, a blue LED, and a green LED, and the arrangement and light type of the LEDs may be varied within the scope of the present disclosure. The LED may be disposed on the upper surface of a substrate, and may emit light having a wavelength ranging from about 430 to 480 nm. A fluorescent material, e.g., yellow phosphor, may be applied on a light emitting surface of the LED such that white light is emitted.

The light source 13 may emit light to the light guide panel 15 at a constant angle, e.g. at an angle of about 120°.

The light guide panel 15 may be transparent, e.g., the light guide panel may be formed of one of acryl-based resin such as polymethyl metaacrylate (PMMA), polyethylene terephthlate (PET), poly carbonate (PC), and polyethylene naphthalate (PEN). The light guide panel may be formed using an extrusion molding method.

Light, incident in a first direction (y-axis direction) from the light source 13, that is, in the lateral direction, may be refracted and diffused upward in a second direction (z-axis direction), that is, to the display panel 210 by the light guide panel 15. The lower surface of the light guide panel 15 is provided with the reflecting member 17 for reflecting light in the second direction.

At least one of the light guide panels 15 may overlap at least one portion of the adjacent light guide panel 15. The lower surface of the light guide panel 15 may be inclined in the second direction from a first side to a second side.

The first side of the light guide panel 15 is provided with the fixing bracket 18 for fixing the light guide panel 15 to the bottom cover 110. The fixing bracket 18 presses at least one of the light guide panel 15 to the bottom cover 110, and is fixed.

The light source 13 is disposed in fixing bracket 18 to prevent light from being emitted from the light source to the outside without passing through the light guide panel 15.

The light guide panel 15 of one of the adjacent optical assemblies 10 overlaps, from the upper side, the fixing bracket 18 of another of the adjacent optical assemblies in at least one portion of the light guide panel 15.

The display panel 210 may have a plurality of division areas corresponding to the light guide panels 15. The intensity of light emitted from the light guide panel 15 of the optical assembly 10, that is, the brightness of light emitted from the light guide panel 15 is adjusted according to a gray level peak value or a color coordinate signal of the corresponding division area, so as to adjust the brightness of the display panel 210.

FIG. 3 is a plan view illustrating the front side of the backlight unit 100. The fixing bracket 18, for fixing the light guide panel 15 to the bottom cover 110, is omitted.

Referring to FIG. 3, the optical assemblies 10 of the backlight unit 100 may be arrayed in an N×M matrix (N is the number of rows arrayed along the y-axis direction, M is the number of columns arrayed along an x-axis direction, and M and N are natural numbers equal to 2 or greater). Each of the optical assemblies 10 may include light source 13 and light guide panel 15.

Each of the optical assemblies is driven in an edge-type backlight manner and operates as a single light source. In this state, the optical assemblies are arrayed in a direct-type backlight manner to constitute backlight unit 100. Thus, the case that the LEDs are detected as a hot spot on a screen can be prevented, and the thickness of light guide panel 15 and the number of optical films can be reduced to achieve the slimness of the backlight unit.

For example, backlight unit 100 may include nine optical assemblies 10 (M1 to M9) in a 3×3 matrix as in FIG. 3, but the present disclosure is not limited thereto. The matrix of optical assemblies can be varied according to a screen size of a display apparatus.

In the current embodiment, the length of light guide panel 15 along the first direction (y-axis direction) is less than the length of the light guide panel along a third direction (x-axis direction) that is perpendicular to the first direction, and light sources 13 are arrayed in the third direction.

Each optical assembly 10 may be manufactured as a discrete assembly or component, and the optical assemblies 10 may be adjacent to each other to constitute a module-type backlight unit that is a backlight member configured to provide light to the display panel 210.

The backlight unit 100 may be driven using an entire driving method or a local driving method such as a local dimming method and an impulsive method. The method of driving the LEDs may be varied according to a circuit design, and thus is not limited. According to the embodiment, a color contrast ratio is increased, and a bright region and a dark region can be sharply expressed on a screen, thereby improving image quality.

The backlight unit 100 may be operated by a plurality of division driving areas corresponding to light guide panels 15, and the brightness of the division driving area is linked with brightness corresponding to an image signal. Thus, the brightness in a dark portion of an image is decreased, and the brightness in a bright portion of the image is increased, so as to improve a contrast ratio and sharpness of the image.

For example, a portion of the optical assemblies 10 (M1 to M9) is independently driven to emit light. To this end, the light sources 13 respectively of the optical assemblies 10 may be independently controlled.

An area of the display panel 210 corresponding to one of the optical assemblies 10 or one of the light guide panels 15 may be divided into two or more blocks, and the display panel 210 and the backlight unit 100 may be dividedly driven in a block unit.

The light sources 13 are disposed on the lower side of the light guide panel 15 on the basis of FIG. 3, but the present disclosure is not limited thereto. For example, the light sources 13 may be disposed on the upper side, left side or right side of light guide panel 15.

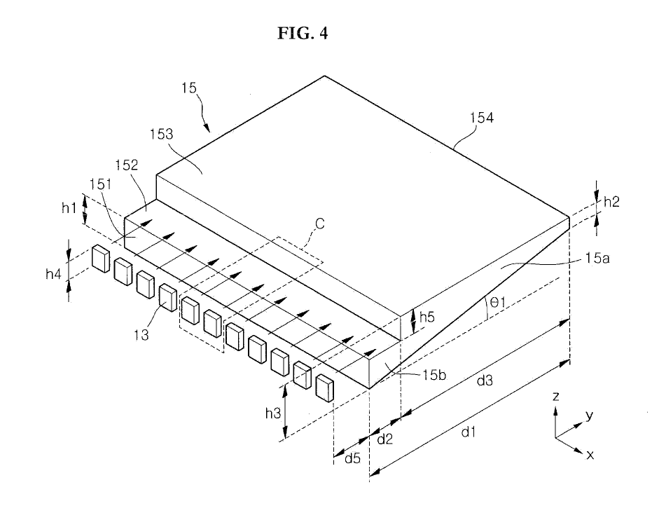

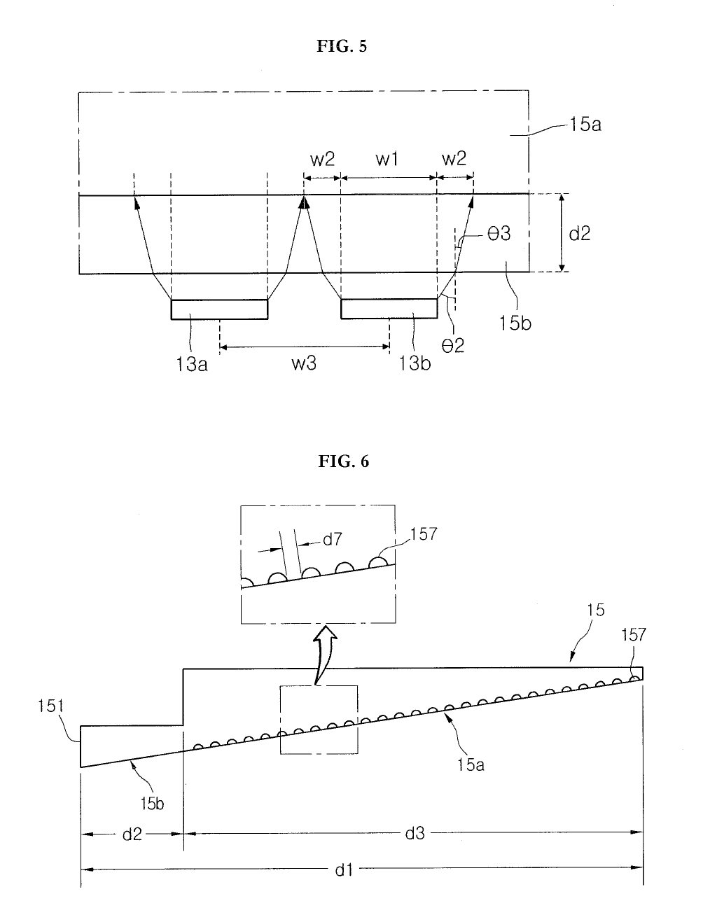

FIG. 4 is a perspective view illustrating the light guide panel 15 and the light sources 13 of FIG. 3. FIG. 5 is an enlarged plan view illustrating a portion C of FIG. 4.

Referring to FIGS. 3 and 4, the light guide panel 15 may include a light incident part 15b, and a light emitting part 15a that decreases in thickness from a first side adjacent to the light incident part 15b to a second side. Light is incident to a first side of the light incident part 15b in the first direction (along the y-axis) as the lateral direction. The light sources 13 are arrayed along a light incident surface 151 disposed on the first side of the light incident part 15b.

The light sources 13 are spaced a constant distance from each other. Streaks of light from the light sources 13 to the light incident surface 151 are mixed into a uniform single streak of light through the light incident part 15b.

As described above, the number of rows of the light guide panels 15 arrayed along the y-axis direction is N (N is 2 or greater). A second end of the light emitting part 15a of the light guide panel 15 in a K^{th} row (K is one of 1 to N−1) of the N rows is disposed above the light incident part 15b of the light guide panel 15 in a K+1^{th} row, so that the two adjacent light guide panels 15 can overlap each other in at least one portion.

The light incident surface 151 faces the light sources 13. When the light sources 13 are completely in contact with the light incident surface 151, the light incident surface 151 may be thermally damaged. Thus, light sources 13 are spaced a predetermined distance d₅ from the light incident surface 151.

A portion of the fixing bracket 18 is placed on an upper surface 152 bent from the light incident surface 151 to press the light guide panel 15 to the bottom cover 110.

When a height of the first side of the light incident part 15b, that is, a height h₁ of the light incident surface 151, and a vertical height h4 of the light sources 13 may satisfy the following Formula 1:

h₄≦h₁≦2×h₄ (1)

That is, the height h₁ of the light incident surface 151 may be equal to or greater than the height h₄ of the light sources 13, and equal to or less than two times the height h₄ of the light sources 13.

For example, the light sources 13 are mounted on the upper surface of a module substrate including a printed circuit board, and the height h₄ of the light sources 13 is defined by the distance from the upper surface of the module substrate to the tops of the light sources 13. At least one portion of the light guide panel 15 may be placed on at least one portion of the module substrate.

When the height h₁ of the light incident surface 151 is less than the height h₄ of the light sources 13, a portion of light emitted from the light sources 13 to the light incident surface 151 is lost. Thus, the height h₁ of the light incident surface 151 may be equal to or greater than the height h₄ of the light sources 13.

As the height h₁ of the light incident surface 151 is increased, light incident efficiency of the light sources 13 to the light incident surface 151 is increased. However, when the height h₁ of the light incident surface 151 is greater than two times the height h₄ of the light sources 13, the light incident efficiency is converged at a constant value. Thus, according to the current embodiment, the height h₁ of the light incident surface 151 may satisfy Formula 1.

The light incident part 15b may extend with a predetermined extension length d₂ from the first side of the light incident part 15b in the first direction (y-axis direction), so as to change light from the light sources 13, as point light sources, to light emitted from a surface light source.

The extension length d₂ of the light incident part 15b in the y-axis direction is determined by factors such as the distance d₅ between the light incident surface 151 and the light sources 13 and a distance between the light sources 13. Hereinafter, the extension length d₂ of the light incident part 15b will now be described in detail.

Referring to FIG. 5, widths of a first light source 13a and a second light source 13b may be w₁, and a width between the centers respectively of the first and second light sources 13a and 13b may be w₃.

That is, the light guide panel 15 is provided with the light sources 13, and a portion of the light sources 13 is selectively lighted according to an external signal. Thus, the light guide panel 15 may be provided with a plurality of sub driving areas.

In this case, light is emitted with a predetermined orientation angle with respect to the first direction from the first and second light sources 13a and 13b to the outside. The orientation angle of light emitted from the borders of the first and second light sources 13a and 13b is denoted by θ₂.

Since the first and second light sources 13a and 13b are spaced the distance d₅ from the light incident surface 151, an air gap may be disposed between the light incident surface 151 and the first and second light sources 13a and 13b.

Accordingly, when light is incident at the orientation angle θ₂ to the light incident surface 151 from the first and second light sources 13a and 13b, the light may be refracted at a refraction angle θ₃ according to Snell's law.

The orientation angle θ₂ and the refraction angle θ₃ may be expressed as the following Formula:

$${θ}_{3} = {sin}^{- 1} ( \frac{{n}_{1}}{{n}_{2}} sin {θ}_{2} ) \qquad ( 2 )$$

where n₁ denotes the refractive index of air, and n₂ denotes the refractive index of the light guide panel 15.

When light incident to the light incident part 15b is spread at the refraction angle θ₃, and then, arrives at the boundary between the light incident part 15b and the light emitting part 15a, a width w₄ of the spread light may satisfy the following Formula 3:

w₄=w₁+2×w₂ (3)

where w₂ denotes a width that is spread left or right from the width w₁ of the first and second light sources 13a and 13b.

The width w₂, spread left or right, may satisfy the following Formula 4:

w₂=d₅ tan θ₂+d₂ tan θ₃≈d₂ tan θ₃ (4)

Since the distance d₅, between the light incident surface 151 and the first and second light sources 13a and 13b, is significantly less than the extension length d₂ of the light incident part 15b, the width w₂ may be approximately expressed as d₂ tan θ₃. According to the current embodiment, the distance d₅ between the light incident surface 151 and the first and second light sources 13a and 13b may be about 1 mm or less. Thus, the width w₄ of the spread light may satisfy Formula 5:

w₄=w₁+2d₂ tan θ₃ (5)

In this case, light emitted from the first light source 13a overlaps light emitted from the second light source 13b when they are spread in the light incident part 15b. The boundary of the light emitted from the first light source 13a is at least in contact with the boundary of the light emitted from the second light source 13b, so that light can be uniformly emitted from the light emitting part 15a. When light emitted from the first light source 13a and spread in the light incident part 15b is spaced apart from light emitted from the second light source 13b and spread in the light incident part 15b, light is emitted with a dark line on the light emitting part 15a, thus degrading image quality.

Thus, width w₃ between the centers respectively of the first and second light sources 13a and 13b may satisfy Formula 6:

w₃≦w₁+2d₂ tan θ₃ (6)

That is, width w₃ between the centers respectively of first and second light sources 13a and 13b may be the spread width w₄ or less, thus preventing a dark line of light emitting part 15a.

According to Formula 6, the extension length d₂ of the light incident part 15b may satisfy Formula 7:

$${d}_{2} \geq \frac{{w}_{3} - {w}_{1}}{2 \times tan {θ}_{3}} = \frac{{w}_{3} - {w}_{1}}{2 \times tan ( {sin}^{- 1} ( \frac{{n}_{1}}{{n}_{2}} sin {θ}_{2} ) )} \qquad ( 7 )$$

That is, the extension length d₂ should be equal to or greater than a predetermined value to prevent a dark line of the light emitting part 15a.

When the extension length d₂ of the light incident part 15b is greater than about 20 mm, optical loss may occur. Accordingly, the entire length of the backlight unit 100 may be increased. Thus, according to the current embodiment, the extension length d₂ of the light incident part 15b may be about 20 mm or less.

Referring again to FIGS. 3 and 4, the light emitting part 15a is disposed on a second side of the light incident part 15b, and emits light, incident to the light incident part 15b, upward, i.e., in the second direction (z-axis direction), so as to provide the light to the display panel 210. According to at least one embodiment, the range of light emitted from the light emitting part may be coextensive with an entire upper surface of the light emitting part, or less.

To emit light in the above manner, the light emitting part 15a may have a predetermined area and extend with an extension length d₃ in the first direction (y-axis direction), and the extension length d₂ of the light incident part 15b and the extension length d₃ of the light emitting part 15a in the first direction may constitute an extension length d₁ of the light guide panel 15 in the first direction.

In this case, the extension length d₃ of the light emitting part 15a may satisfy Formula 8:

$$\frac{{L}_{1}}{50} \leq {d}_{3} \leq \frac{{L}_{1}}{6} \qquad ( 8 )$$

where L₁ denotes an extension length of the backlight unit 100 in a longitudinal direction (y-axis direction). See FIG. 3. That is, in the current embodiment, the light guide panels 15 are arrayed in 6 to 50 lines in the backlight unit 100.

When the number of lines in which the light guide panels 15 are arrayed is less than 6, the efficiency of the division light-emitting driving of the respective light guide panels 15, that is, the efficiency of local dimming of the respective light guide panels 15 is decreased, and power consumption according to the driving of the backlight unit 100 is significantly increased.

That is, as the number of lines in which the light guide panels 15 are arrayed is increased, the efficiency of the local dimming is improved and the power consumption is decreased.

When the number of lines in which the light guide panels 15 are arrayed is greater than 50, the increase rate in the efficiency of the local dimming and the decrease rate in the power consumption are converged at constant values.

Thus, in the current embodiment, the number of lines in which the light guide panels 15 are arrayed in the backlight unit 100 may range from 6 to 50. In this case, the light guide panels 15 may be arrayed along the direction in which the light sources are arrayed.

The extension length d₂ of the light incident part 15b and the total extension length d₁ of the light guide panel 15, i.e., the sum of the extension length d₂ of the light incident part 15b and the extension length d₃ of the light emitting part 15a may satisfy Formula 9:

$$0.03 < \frac{{d}_{2}}{{d}_{1}} < 0.2 \qquad ( 9 )$$

That is, when the ratio of the extension length d₂ of the light incident part 15b to the total extension length d₁ of the light guide panel 15 is 0.03 or less, the extension length d₂ of the light incident part 15b may be insufficient, and thus, light emitted from the light sources 13 to the outside may have a point light source shape.

When the ratio of the extension length d₂ of the light incident part 15b to the total extension length d₁ of the light guide panel 15 is 0.2 or greater, the extension length d₂ of the light incident part 15b is so great as to cause optical loss, and the entire volume of the backlight unit 100 may be increased.

Thus, according to the current embodiment, the ratio of the extension length d₂ of the light incident part 15b to the total extension length d₁ of the light guide panel 15 satisfies Formula 9. The light emitting part 15a may include an upper surface functioning as a surface light source, a lower surface facing the upper surface, and four side surfaces.

The lower surface of the light guide panel 15 is inclined upward from the end of the first side of the light incident part 15b to the end of the second side of the light emitting part 15a, and provided with the reflecting member 17 that reflects light, incident through the light incident part 15b, in the second direction.

The lower surface of the light guide panel 15 is inclined at an inclined angle θ₁ that may satisfy Formula 10:

$$0 < {θ}_{1} \leq {tan}^{- 1} ( \frac{{h}_{3}}{{d}_{2} + {d}_{3}} ) \qquad ( 10 )$$

where h₃ denotes the entire height of the light guide panel 15. That is, the inclined angle θ₁ is greater than 0, and is equal to or less than the maximum of Formula 10.

In this case, when the inclined angle θ₁ is the maximum of Formula 10, a height h₂ of a second end 154 of the light emitting part 15a is converged to 0. That is, as the height h₂ of the second end 154 is decreased, the inclined angle θ₁ is increased, and the efficiency of light reflected from the lower surface of the light guide panel 15 to an upper surface 153 of the light emitting part 15a is increased.

According to at least one embodiment, the height h2 of the distant end of the light emitting part is based on a height difference between the upper surfaces of the light incident part and light emitting part and an angle of inclination of a lower surface of the light emitting part.

When the ratio of height h₂ of light guide panel 15 to height h₁ of light incident surface 151 of the light guide panel 15 is a predetermined value or less, the strength of the end of the light guide panel 15 is decreased, and thus, the end of the light guide panel 15 may be broken.

When the ratio of the height h₂ of the light guide panel 15 to the height h₁ of the light incident surface 151 of the light guide panel 15 is 1 or greater, light emitting efficiency of light emitted from the light emitting part 15a in the first direction may be reduced.

Thus, the height h₂ of the light guide panel 15 may satisfy Formula 11:

$$0.2 < \frac{{h}_{2}}{{h}_{1}} < 1.0 \qquad ( 11 )$$

The light emitting part 15a is different in height from the light incident part 15b in a region where the first side of the light emitting part 15a is in contact with the second side of the light incident part 15b such that the fixing bracket 18 presses and fixes the light guide panel 15 to the bottom cover 110 and light spread efficiency is increased.

That is, a step part having a height h5 is disposed between the upper surface 152 of the light incident part 15b and the upper surface 153 of the light emitting part 15a.

Thus, the entire height h3 of light guide panel 15 and the thickness of the light incident part 15b, that is, the height h1 of light incident surface 151 are different from each other, and may satisfy Formula 12. In this case, the entire height h3 of light guide panel 15 may be the sum of height h1 of light incident surface 151 and the height h₅ of the step part.

$$1.2 < \frac{{h}_{3}}{{h}_{1}} < 2.5 \qquad ( 12 )$$

That is, when the ratio of the entire height h3 of light guide panel 15 to the height h1 of light incident part 15b is 1.2 or less, stress is concentrated on the light incident part 15b while the light guide panel 15 is formed, so that light guide panel 15 may be bent.

In addition, when the ratio of the entire height h3 of the light guide panel 15 to the height h1 of the light incident part 15b is 2.5 or greater, aberration of light due to thickness difference causes a dark area at the front side of the light incident part 15b, that is, at a contact between the light incident part 15b and the light emitting part 15a.

Thus, in the current embodiment, the ratio of the entire height h3 of the light guide panel 15 to the height h1 of the light incident surface 151 satisfies Formula 12.

When the height h2 of the second end 154 of the light emitting part 15a is greater than the height h5 of the step part, the inclination angle of the lower surface of the light guide panel 15 is decreased. Thus, the reflectance of the light guide panel 15 is decreased, and the efficiency of light emitted from the light emitting part 15a to the upper surface 153 is decreased. This causes light interference in which light that does not pass through the upper surface 153 is leaked into the adjacent light guide panel 15 through the second end 154. Thus, the height h2 of the second end 154 of the light emitting part 15a is less than or equal to the height h5 of the step part.

When the height h1 of the light incident surface 151 is less than the height h5 of the step part, light traveling from the light incident part 15b to the light emitting part 15a is excessively diffused, so that a dark region is generated on the first side of the light emitting part 15a contacting the light incident part 15b. Thus, the height h1 of the light incident surface 151 is greater than or equal to the height h5 of the step part. The upper surface 152 form a ledge for the step having a height h1, and the upper surface 153 form a second ledge for the step having the height h5.

From the relationship between the height h1 of the light incident surface 151 and the height h5 of the step part, and from the relationship between the height h5 of the step part and the height h2 of the second end 154 of the light emitting part 15a, the height h1 of the light incident surface 151 is equal to or greater than the height h2 of second end 154.

FIG. 6 is a cross-sectional view taken along the first direction of the light guide panel 15. Referring to FIG. 6, the lower surface of the light guide panel 15 may be provided with optical patterns 157 that are disposed in the third direction (x-axis direction) perpendicular to the direction of spread light, that is, to the first direction (y-axis direction), so as to efficiently spread light from the second side of the light incident part 15b to the first side of the light emitting part 15a.

More particularly, the optical patterns 157 are spaced a distance d7 from each other on the inclined lower surface of the light guide panel 15. In this case, the optical patterns 157 may be disposed from the first side of the light emitting part 15a adjacent to the second side of the light incident part 15b to the second end 154 of the light emitting part 15a.

The distance d7 of the optical patterns 157 may be varied according to the distances between the light incident surface 151 and the optical patterns 157. That is, the distance between the optical patterns 157 may be decreased in the direction distant from the light incident surface 151, so as to increase the density of the optical patterns 157 in the distant direction. Since the brightness of the light guide panel 15 is decreased in the distant direction from the light incident surface 151, the density of the optical patterns 157 is increased to improve light spread, thereby securing the entire brightness uniformity of the light guide panel 15. For example, the optical patterns 157 may be formed in concave or convex shape on the lower surface of the light guide panel 15.

Although optical patterns 157 are disposed only in light emitting part 15a in the current embodiment, optical patterns 157 may be disposed in light incident part 15b.

According to the embodiments, the module-type backlight unit including the light guide panels provides light to the display panel. Thus, the thickness of the display apparatus can be decreased, and contrast of a displayed image can be improved using the entire driving method or the local driving method such as the local dimming method and the impulsive method.

Since the backlight unit is driven using the local dimming method, the entire power consumption of the display apparatus can be reduced.

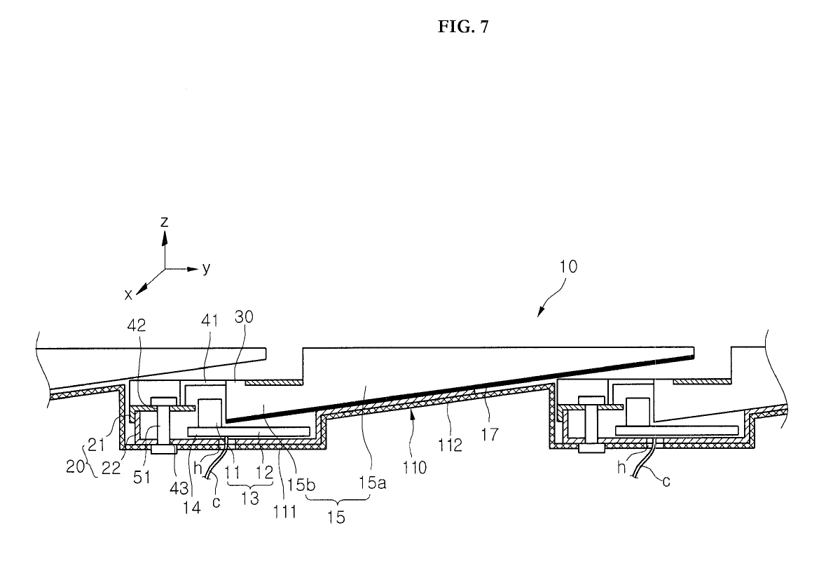

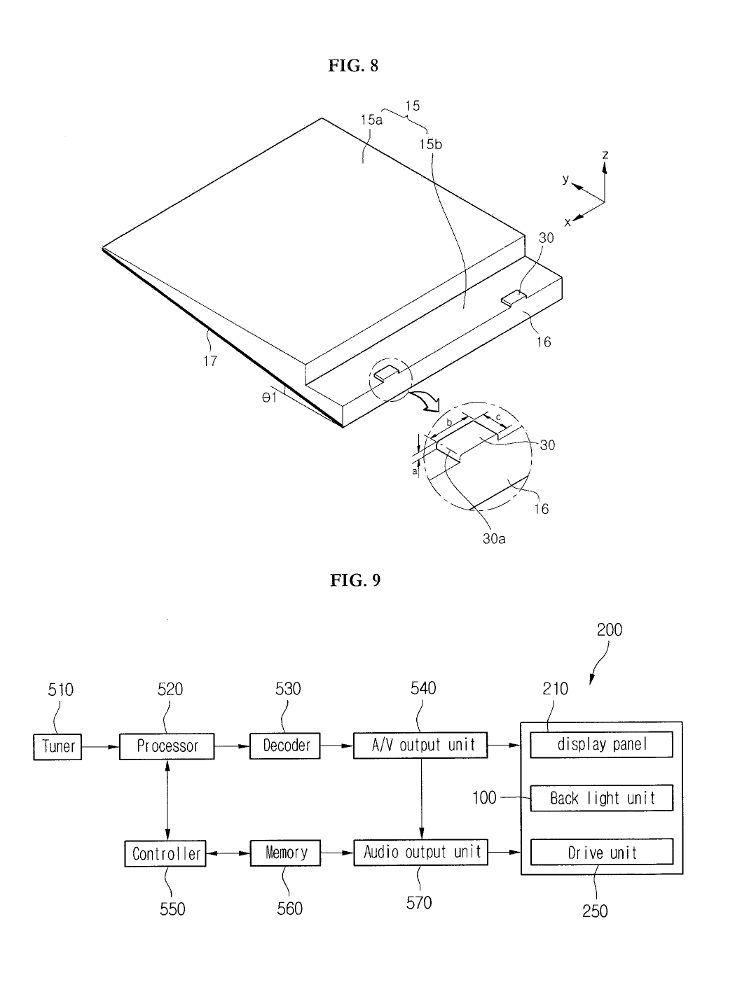

FIG. 7 is a cross-sectional view illustrating a backlight unit according to an embodiment. FIG. 8 is a schematic view illustrating the light guide panel 15 of FIG. 7. A description of the same parts as those of FIGS. 1 to 6 will be omitted.

Referring to FIGS. 7 and 8, the optical assembly 10 may include the light source 13, the light guide panel 15, the reflecting member 17, and a side cover 20 for fixing the light source 13 and the light guide panel 15. The side cover 20 provides a fixing position with respect to the bottom cover 110 and surrounds the light source 13 and a portion of the light guide panel 15. The light source 13 is disposed in the side cover 20.

The side cover 20 may include a first side cover 21 disposed on the light source 13 and the light incident part 15b of the light guide panel 15, and a second side cover 22 disposed under the light incident part 15b. Side cover 20 may be plastic or metal.

The first side cover 21 is coupled to the second side cover 22 through a first fixing member 51 to prevent the shaking of the light source 13 and the light guide panel 15 due to external shock, and particularly, prevent the shaking along the z-axis.

The second side cover 22 supports the inclined surface of the light guide panel 15 to firmly maintain alignment of the light guide panel 15 with the light source 13 and protect the light guide panel 15 and the light source 13 from external shock.

The light incident part 15b of the light guide panel 15 may include a protrusion 30 protruding with a predetermined height ‘a’. The protrusion 30 may be provided to at least two points in the x-axis direction on the upper surface of the light incident part 15b of the light guide panel 15.

The shape of protrusion 30 may be varied. For example, the protrusion 30 may have a rectangular parallelepiped shape. The protrusions 30 are caught by the first side cover 21 to prevent the shaking of the light guide panel 15 along the x-axis and the y-axis.

An edge 30a of the protrusion 30 may be rounded to prevent a case that a crack is formed at protrusion 30 by shock due to the movement of the light guide panel 15.

The height ‘a’ of the protrusion 30 may range from about 0.3 to 0.6 mm from the upper surface of the first part light incident part 15b. The protrusion 30 may have a width ‘b’ ranging from about 2 to 5 mm along the x-axis. The protrusion 30 may have a width ‘c’ ranging from about 1 to 3 mm along the y-axis.

The protrusion 30 may be disposed between neighboring LEDs 11 and adjacent to a light incident surface 16 on the upper surface of the light incident part 15b, so as to prevent optical interference of light emitted from the LEDs 11 due to the protrusion 30 integrally formed with the light guide panel 15.

The LEDs 11 may be spaced a predetermined distance from each other. The LEDs 11 may be disposed in an oblique direction with respect to the protrusion 30 to minimize optical effect due to the protrusion 30 of the light guide panel 15. Accordingly, the distance between the LEDs 11 around the protrusion 30 may be greater than the distance between the other LEDs 11.

The distance between a portion of the LEDs 11 may be greater than the distance between the other LEDs 11 to secure a coupling space of the first side cover 21 and the second side cover 22 and minimize optical effect due to coupling force for pressing the light guide panel 15.

The first side cover 21 may have first holes 41 at positions corresponding to the protrusions 30 of the light incident part 15b.

The first holes 41 may be larger than the protrusions 30 such that the protrusions 30 are fitted and caught to the first holes 41. The protrusion 30 disposed in the first hole 41 partially has a predetermined gap that may be a margin for preventing the torsion of the light guide panel 15 when the light guide panel 15 is expanded by environmental change such as sharp temperature increase. In this case, the rest of the protrusion 30 without the predetermined gap may be in contact with the first side cover 21 to increase fixing force thereof.

At least one second hole 42 may be further disposed in the first side cover 21. The second side cover 22 may have at least one third hole 43 at a position corresponding to the second hole 42. The backlight unit 100 configured as described above may be disposed in the bottom cover 110 having a box shape with an open top.

The bottom cover 110 includes a recess part 111 to which the optical assembly 10 is fixed, and a projection part 112 disposed under the inclined portion of the light guide panel 15 of the optical assembly 10 and protruding from the recess part 111 in the second direction (z-axis direction).

A hole h passes through both the bottom cover 110 and the side cover 20. A cable c extending from a substrate 14 may be connected through the hole h to a driving substrate 250 that is provided to the rear surface of the bottom cover 110.

FIG. 9 shows operating elements for a display apparatus according to an embodiment.

Referring to FIG. 9, the display apparatus 1 includes the display module 200, a tuner 510, a processor 520, a decoder 530, an A/V output unit 540, a controller 550, a memory 560, and an audio output unit 570.

A broadcast data stream is transmitted from the tuner 510 through the processor 520, the decoder 530, and the A/V output unit 540 to the display module 200, and is displayed.

An operation of the tuner 510 or the processor 520 may be controlled by the controller 550 that may include the memory 560.

When the display apparatus 1 configured as described above is operated to select an arbitrary channel, the controller 550 controls the tuner 510 and the processor 520 to select the channel, and the processor 520 divides a data stream of a broadcast program, provided through the channel, into an audio data and a video data, and outputs them.

Then, the decoder 530 decodes the audio data and the video data output from the processor 520 into an audio signal and a video signal, so that the audio signal and the video signal can be output through the A/V output unit 540 to the display module 200 or the audio output unit 570 such as a speaker unit.

A driving unit 250 drives the backlight unit 100 to display the output video signal on the display panel 210.

A broadcast data stream transmitted to the processor 520 may be provided through the Internet.

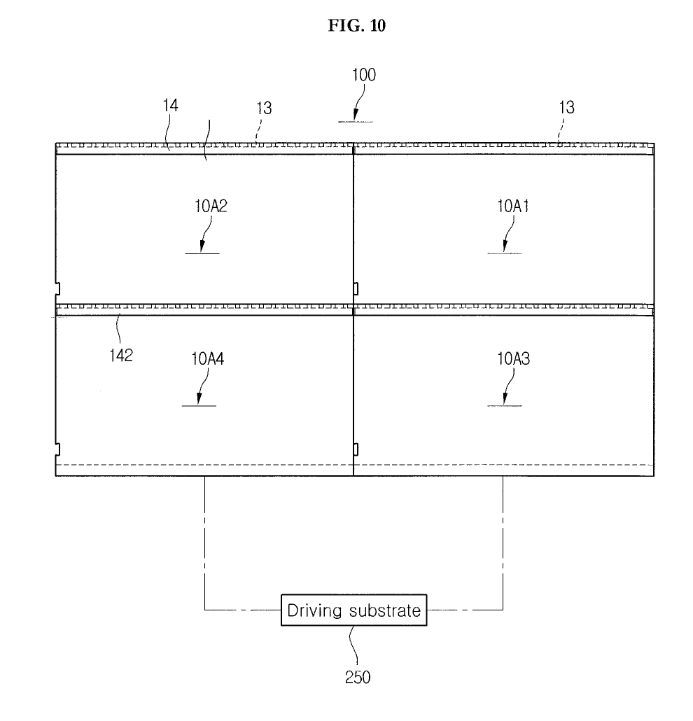

FIG. 10 shows operating elements for a back light unit according to an embodiment.

Referring to FIG. 10, a plurality of optical assemblies 10A1, 10A2, 10A3, 10A4, each of which includes the light guide panel 15 and the reflecting member 17, are arrayed to form the backlight unit 100.

That is, the circuit substrates 14 and the light sources 13 are disposed on one side or two sides of the light guide panel, and the optical assemblies 10A1, 10A2, 10A3, 10A4 including the light guide panels 15 and the reflecting members 17 are arrayed on the light guide parts 110, so as to constitute the backlight unit 100.

The backlight unit 100 fabricated by coupling the optical assemblies 10A1, 10A2, 10A3, 10A4 as described above, or the light sources 13 connected to the backlight unit 100 may be independently or divisionally driven in group units by the driving substrate 250, thus significantly reducing power consumption of the backlight unit 100.

In this case, the division driving may be set and performed in module units, in light source units of the light sources 13, or in light source set units that are logically grouped.

That is, the light sources 13 may be grouped into primary light source groups that constitute sides respectively of modules, so that the light sources 13 can be driven in primary group units. Alternatively, the light sources 13 may be grouped into sub groups of the light sources 13 that constitute sides respectively of modules, so that the light sources 13 can be driven in sub group units.

As described above, according to the current embodiment, the light guide panels 15 are minimized, and the light sources 13 are continuously attached to the side surfaces of the light guide panels 15, thus securing a predetermined amount of light and dissipating heat. Specifically, the light sources 13 attached to the side surfaces of the light guide panels 15 are optically hidden.

According to the embodiment of FIG. 1, the small light guide panels are continuously attached to each other in light guide module manner to constitute the entire area of the display. Thus, the light sources can be disposed between the light guide panels, and the identical light guide panels can be used regardless of the size of the display.

The light guide panels are provided in module form, and continuously attached in the manner, so as to form a large screen. Thus, identical parts can be applied to various sizes of televisions by varying the number thereof, so that the parts can be standardized.

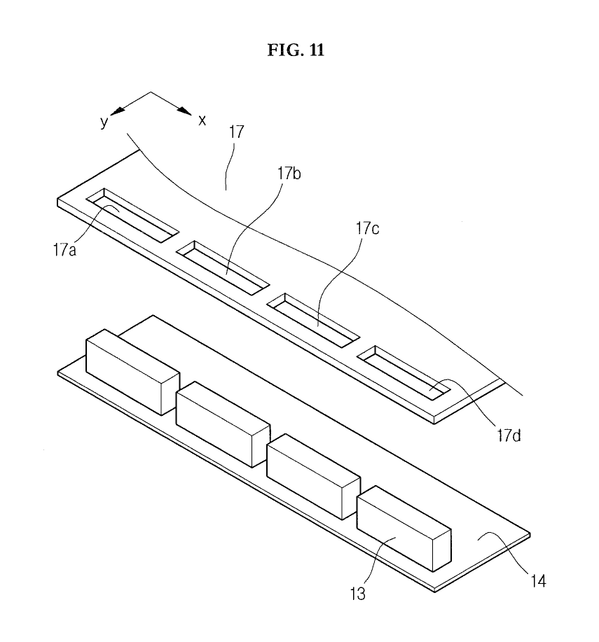

FIG. 11 is a perspective view illustrating a reflecting element and a substrate according to an embodiment.

Referring to FIG. 11, at least one portion of the reflecting member 17 of the optical assembly 10 is placed on the substrate 14. The portion of the reflecting member 17 placed on the substrate 14 is provided with holes 17a, 17b, 17c, and 17d through which the light sources 13 arrayed on the substrate 14 pass.

In more detail, the holes 17a, 17b, 17c, and 17d have shapes and sizes corresponding to the light sources 13, and disposed at positions corresponding to the light sources 13.

Thus, when assembling the optical assembly 10, the light sources 13 are inserted into the holes 17a, 17b, 17c, and 17d of the reflecting member 17, so that the position of the reflecting member 17 relative to the substrate 14 can be fixed.

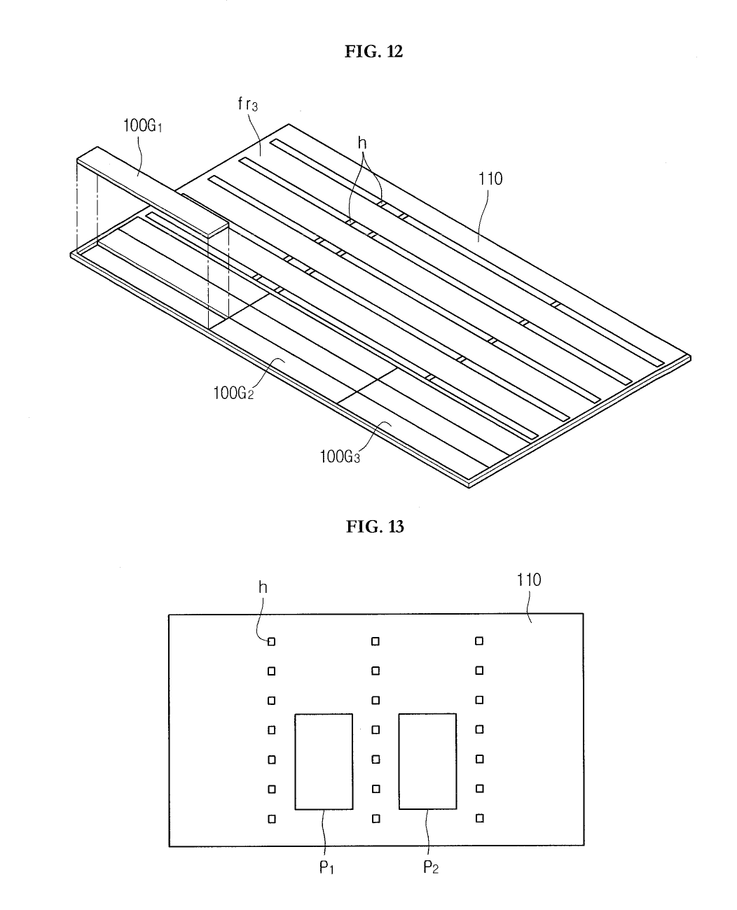

FIG. 12 is a perspective view illustrating a backlight unit according to an embodiment, and FIG. 13 is a plan view of a rear surface of a bottom cover of FIG. 12.

The current embodiment is the same as the embodiment of FIG. 1 except for a bottom cover and an optical assembly, which will be described in detail.

Referring to FIGS. 12 and 13, a plurality of optical assemblies 100G1, 100G2, and 100G3 are arrayed in three lines on the bottom cover 110 of the backlight unit 100. A plurality of holes h are disposed in the bottom cover 110 to connect connection parts 148 provided to the rear surfaces of the substrates 14 respectively of the optical assemblies 100G1, 100G2, and 100G3 to driving substrates P1 and P2 provided to the rear surface of the bottom cover 110.

In more detail, the optical assemblies 100G1, 100G2, and 100G3 are arrayed in one to three lines on the bottom cover 110. The connection parts 148 of the substrates 14 may be directly disposed on the bottom cover 110 in correspondence with the line or the lines, or the holes h for connecting the connection parts 148 to the driving substrates P1 and P2 may be disposed in the bottom cover 110 in correspondence with the line or the lines.

The driving substrates P1 and P2 are provided to the rear surface of the bottom cover 110, and may be referred to as a first driving substrate and a second substrate, respectively.

The first driving substrate P1 is disposed between neighboring first and second lines of the three lines, and the second driving substrate P2 is disposed between neighboring second and third lines of the three lines.

Hereinafter, a configuration of the substrate 14 of the optical assembly 10 will now be described in detail.

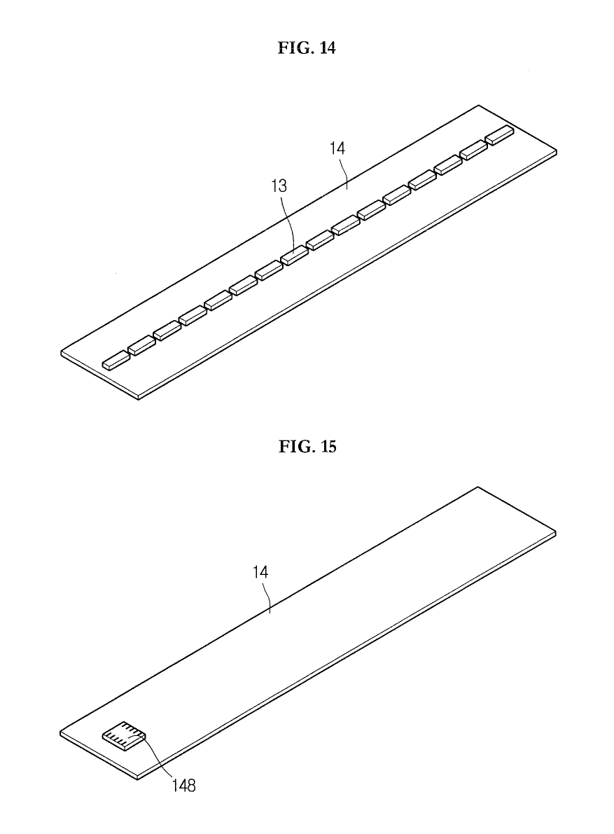

FIG. 14 is a perspective view of a substrate of an optical unit of FIG. 12, and FIG. 15 is a perspective view of a rear surface of the substrate of FIG. 14.

Referring to FIGS. 14 and 15, the light sources 13 are disposed on a surface of the substrate 14, and the connection part 148 is disposed on an inner surface of the substrate 14 facing the bottom cover 110.

The connection part 148 is connected with a cable member (not shown) for transmitting a control signal from the driving substrates P1 and P2, and protrudes from the inner surface of the substrate 14 to the bottom cover 110.

The connection part 148 may directly pass through the hole h provided to the bottom cover 110.

The cable member has a side connected to the connection part 148, and another side connected to the driving substrates P1 and P2, to transmit the control signal of the driving substrates P1 and P2 through the connection part 148 to the substrate 14 and the light sources 13.

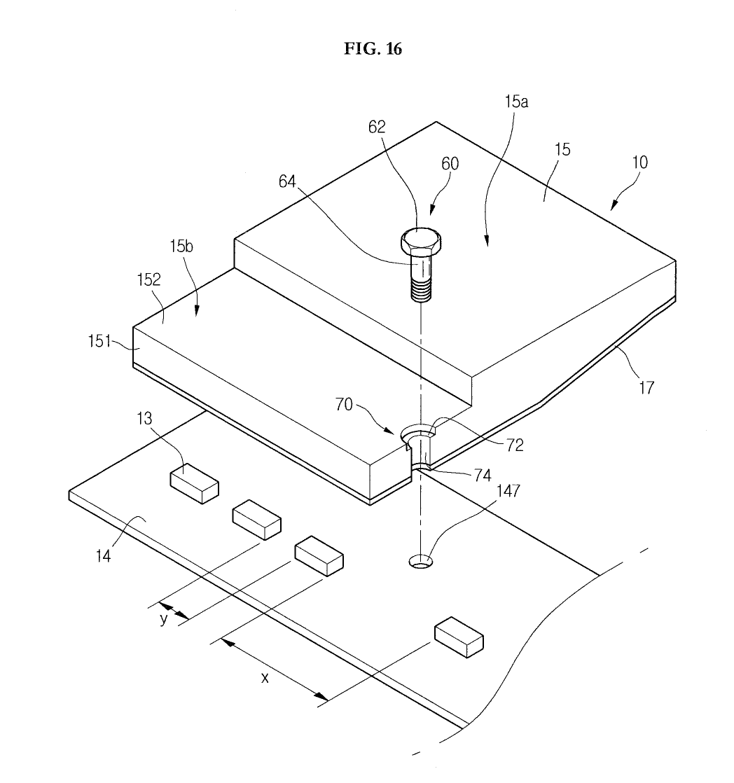

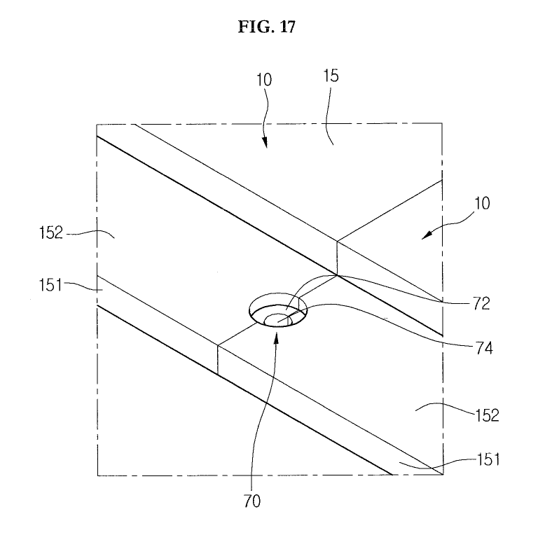

FIG. 16 is an exploded perspective view of an optical assembly according to an embodiment, and FIG. 17 is a perspective view of two light guide panels that are aligned of FIG. 16.

The current embodiment is the same as the embodiment of FIG. 1 except for a fixing structure of a light guide panel, which will now be described in detail.

Referring to FIGS. 16 and 17, the light incident part 15b of the light guide panel 15 of the optical assembly 10 is provided with a fixing part 70, e.g., a hole, where a fixing member 60, e.g., a screw, rivet or any other appropriate fastener, for fixing the light guide panel 15 to the substrate 14 or the bottom cover 110, is disposed.

The fixing part 70 of one of the adjacent light guide panels 15 is in contact with the fixing part 70 of the other to have a shape corresponding to the entire shape of the fixing member 60.

The fixing part 70 includes a recess part 72 that is disposed in the upper surface 152 of the light incident part 15b, and a through part 74 that passes through the lower side of the recess part 72. The recess part 72 is recessed with a diameter and a thickness corresponding to a head part 62 of the fixing member 60. A fixing member body 64 of the fixing member 60 having a spiral is inserted and fixed to the through part 74.

The substrate 14 is provided with a fixing hole 147 that is disposed at a position corresponding to the through part 74 to fix at least one portion of the fixing member body 64 passing through the through part 74. A distance x between the light sources 13 at a portion where the fixing hole 147 is disposed is greater than a distance y between the light sources 13 at a portion without the fixing hole 147 to prevent optical interference due to the fixing member 60.

Thus, when the light guide panels 15 of the backlight unit 100 are adjacent to each other, the fixing member body 64 passes through the through part 74 and is fixed to the substrate 14 or the bottom cover 110, and the head part 62 provided to the side of the fixing member body 64 compresses the recess part 72 to the substrate 14 or the bottom cover 110, thus fixing the light guide panels 15 to the substrate 14 or the bottom cover 110.

Although the configurations according to the aforementioned embodiments are provided independently, they may be combined to each other.

According to the embodiments, the module-type backlight unit including the light guide panels provides light to the display panel. Thus, the thickness of the display apparatus can be decreased, and contrast of a displayed image can be improved using the entire driving method or the local driving method such as the local dimming method and the impulsive method. Since the backlight unit is driven using the local dimming method, the entire power consumption of the display apparatus can be reduced.

Embodiments provide a backlight unit and a display apparatus including the same, which improve quality of a displayed image.

In one embodiment, a backlight unit includes: a substrate; a plurality of light sources on the substrate, the light sources emitting light with a predetermined orientation angle with respect to a first direction; and a light guide panel including: a light incident part having a light incident surface to which streaks of light respectively emitted from the light sources are laterally incident; and a light emitting part emitting the incident streaks of light upward and having a side adjacent and connected to the light incident part, wherein a height of the light source is less than or equal to a height of the light incident surface, and a height of a step part, formed by a height difference between an upper surface of the light incident part and an upper surface of the light emitting part, is greater than or equal to a height of a distant end of the light emitting part from the light incident part.

In another embodiment, a backlight unit includes: one or more substrates; a plurality of light sources on the substrate, the light sources emitting light with a predetermined orientation angle with respect to a first direction; and N (N is 2 or greater) light guide panels each including: a light incident part having a light incident surface to which streaks of light respectively emitted from the light sources are laterally incident; and a light emitting part emitting the incident streaks of light upward and having a side adjacent and connected to the light incident part, wherein at least one portion of the light emitting part of a Kth (K is one of 1 to N−1) light guide panel of the N light guide panels is disposed on an upper side of the light incident part of a K+1th light guide panel, the light guide panel includes a portion that gradually decreases in thickness in a direction distant from the light incident part, a height of the light source is less than or equal to a height of the light incident surface, and a height of a step part, disposed between an upper surface of the light incident part and an upper surface of the light emitting part, is greater than a height of a distant end of the light emitting part from the light incident part.

In further another embodiment, a display apparatus includes: a display panel; a backlight unit on a rear side of the display panel, the backlight unit including a plurality of driving areas that are independently drivable corresponding to a grey level peak value or color coordinate signal of the display panel; and a driving part on a rear side of the backlight unit, the driving part driving at least one of the display panel and the backlight unit, wherein the backlight unit includes: a substrate; a plurality of light sources on the substrate, the light sources emitting light with an orientation angle; and a light guide panel including: a light incident part having a light incident surface to which streaks of light respectively emitted from the light sources are laterally incident; and a light emitting part emitting the incident streaks of light upward and having a side adjacent and connected to the light incident part, wherein a height of the light source is less than or equal to a height of the light incident surface, and a height difference between an upper surface of the light incident part and an upper surface of the light emitting part is greater than or equal to a height of a distant end of the light emitting part from the light incident part.

The present disclosure also provides a “green” technology for display devices. Presently, the backlight is generally turned on continuously, even when the display of the entire screen is not desirable. For example, the prior art display allows control of the resolution of the entire display screen but not the size of the display screen. However, in certain instances, a smaller screen area may be desirable for lower resolution images. The size of the display area can be controlled based on the present disclosure. For example, instead of viewing images and programs in 42 inch display, the display screen size can be reduce to 32 inches by turning off the light sources for appropriate number of light guide plates located at the periphery of the display device. As can be appreciated, the location and size of the display area can be controlled based on program or user needs. As can be appreciated, multiple configuration may be possible based on turning on or off the light sources for appropriate number of light guide plates (light guide panels or light guide modules or assemblies) based on application and user configuration.

This application is related to Korean Applications Nos. 10-2008-0049146 filed on May 27, 2008, 10-2008-0061487 filed on Jun. 27, 2008, 10-2008-0099569 filed on Oct. 10, 2008, 10-2009-0035029 filed on Apr. 22, 2009 10-2009-0036472 filed Apr. 27, 2009, 10-2009-0052805 filed on Jun. 15, 2009, 10-2009-0061219 filed Jul. 6, 2009, 10-2009-0072449 filed Aug. 6, 2009, 10-2009-0075120 filed on Aug. 14, 2009, 10-2009-0080654 filed Aug. 28, 2009, 10-2009-0098844 filed on Oct. 16, 2009, and 10-2009-0098901 filed on Oct. 16, 2009, whose entire disclosures are incorporated herein by reference. Further, this application is related to U.S. Provisional Patent Application No. 61/219,480 filed on Jun. 23, 2009; 61/229,854 filed on Jul. 30, 2009; 61/233,890 filed on Aug. 14, 2009; and 61/237,841 filed on Aug. 28, 2009 and U.S. application Ser. No. 12/453,885 filed on May 22, 2009, Ser. No. 12/618,603 filed on Nov. 13, 2009, Ser. No. 12/632,694 filed on Dec. 7, 2009, and LGE-162, LGE-163, HI-0400, HI-0412, HI-0413, HI416 and HI-0420 all filed on Mar. 19, 2010, whose entire disclosures are incorporated herein by reference.

It will be apparent to those skilled in the art that various modifications and variations can be made in the present disclosure without departing from the spirit or scope of the present disclosure. Thus, it is intended that the present disclosure cover the modifications and variations of this present disclosure provided they come within the scope of the appended claims and their equivalents.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A backlight unit comprising:
a plurality of light guide panels, at least one light guide panel having a light incident to receive light from a first direction and a light emitting section adjacent to the light incident section to emit light received from the light incident section in a second direction, the first and second directions being different directions; and
a plurality of light sources, the incident section of at least one light guide panel being adjacent to at least one light source to receive light output,
a first portion of the light incident section closest to the at least one light source having a first prescribed height, a first portion of the light emitting section closest to the light incident section in the first direction has a second prescribed height, and a second portion of the light emitting section farthest from the light incident section in the first direction has a third prescribed height, the difference between the first and second prescribed heights being greater than or substantially equal to the third prescribe height.

2. The backlight unit according to claim 1, wherein the difference in the first and second prescribed heights corresponds to an elevation difference between a top surface of the light incident section and a top surface of the light emitting section.

3. The backlight unit of claim 1, wherein an angle of inclination of a lower surface of the light emitting section is an acute angle.

4. The backlight unit of claim 1, wherein a height of the light sources is less than or substantially equal to the first prescribed height.

5. The backlight unit of claim 1, wherein a height of the light emitting section decreases from the second height to the third prescribed height.

6. The backlight unit of claim 1, wherein the first prescribed height of the light incident section is substantially equal to or less than two times the height of each light source.

7. The backlight unit of claim 1, wherein the plurality of light guide panels is divided into a plurality of division driving areas, wherein the light guide panels in at least one division driving area emit light independently from the light guide panels in at least one other division driving areas such that a brightness of the at least one division driving area is different from brightness of the at least one other division driving areas.

8. The backlight unit of claim 1, wherein the light incident section is spaced a predetermined distance from the light sources

9. The backlight unit of claim 8, wherein an extension length d₂ of the light incident section along the first direction satisfy the following:
$$\frac{{w}_{3} - {w}_{1}}{2 \times tan ( {sin}^{- 1} ( \frac{{n}_{1}}{{n}_{2}} sin {θ}_{2} ) )} \leq {d}_{2} \leq 20 mm .$$
where w₁ is a width of the light source, w₃ is a width between centers of adjacent light sources, an orientation angle Θ₂ is an orientation angle of light emitted from the light source, n₁ is a refractive index of a gap between the light incident section and the light source, and n₂ is a refractive index of the light incident section.

10. The backlight unit of claim 1, wherein the light guide panels are arrayed along an axis parallel to the first direction, wherein an extension length d₃ of the light emitting section corresponding to a distance from the first portion to the second portion satisfy the following:
$$\frac{{L}_{1}}{50} \leq {d}_{3} \leq \frac{{L}_{1}}{6}$$
where a border L₁ is an entire length of the arrayed light guide panels in the first distance.

11. The backlight unit of claim 10, wherein the plurality of light guide panels are further arrayed in a third direction, the third direction being perpendicular to the first and second directions.

12. The backlight unit of claim 1, wherein the light incident section has an extension length d₂ in the first direction corresponding to a distance between the first portion of the light incident section to the first portion of the light emitting section and a distance between the first portion of the light incident section and the second portion of the light emitting section corresponds to a sum d₁ wherein d2 and d1 satisfy the following:
$$0.03 < \frac{{d}_{2}}{{d}_{1}} < 0.2$$

13. The backlight unit of claim 1, wherein the light guide panel has an inclined lower surface and wherein an angle of inclination θ₁ of the lower surface of the light guide panel satisfy the following formula:
$$0 < {θ}_{1} \leq {tan}^{- 1} ( \frac{{h}_{3}}{{d}_{2} + {d}_{3}} ) .$$
where h₃ is an entire height of the light guide panel, and extension length d₂ corresponds to a distance between the first portion of the light incident section to the first portion of the light emitting section, and extension length d₃ corresponds to a distance from the first portion to the second portion of the light emitting section.

14. The backlight unit of claim 1, wherein the first prescribed height h₁ and the third prescribed height h₂ satisfy the following:
$$0.2 < \frac{{h}_{2}}{{h}_{1}} < 1.0 .$$

15. The backlight unit of claim 1, wherein the first prescribed height h₁ of the light incident section and a total height h₃ corresponding to a sum of the first prescribed height h₁ and the second prescribed height satisfy the following:
$$1.2 < \frac{{h}_{3}}{{h}_{1}} < 2.5 .$$

16. The backlight unit of claim 1, wherein a lower surface of the light guide panel includes a plurality of recesses forming an optical pattern.

17. The backlight unit of claim 1, further comprising:
a cover provided over a portion of an upper surface of the light guide panel.

18. The backlight unit of claim 17, wherein the cover further covers a portion of a lower surface of the light guide panel and the light source.

19. The backlight unit of claim 1, wherein the first prescribed height of the light incident section is greater than or substantially equal to the third prescribed height of the light emitting section.

20. The backlight unit of claim 1, wherein the first prescribed height of the light incident section is greater than or substantially equal to the second prescribed height of the light emitting section.

21. The backlight unit of claim 1, wherein light source is provided over a substrate and comprises a light emitting diode emitting light having a wavelength ranging from about 430 to 480 nm, and a light emitting surface of the light emitting diode having a fluorescent material.

22. The backlight unit of claim 21, wherein the fluorescent material is yellow phosphor.

23. The backlight unit of claim 1, wherein the plurality of light guide panels comprises N number of light guide panels, N being at least 2, wherein at least one portion of the light emitting section of a K^{th} (K is one of 1 to N−1) light guide panel of the N light guide panels is overlay an upper side of the light incident section of a K+1^{th} light guide panel.

24. The backlight unit of claim 23, wherein the upper surface of the light emitting section of the Kth light guide panel is substantially level with an upper surface of a light emitting section of the adjacent (k+1) light guide panel.

25. The backlight unit of claim 23, wherein the second portion of the light emitting section of the at least one light guide panel overlaps at least a portion of the light incident section of an adjacent light guide panel.

26. A display apparatus having the backlight unit of claim 1, wherein the display apparatus includes:
a display panel adjacent the backlight unit; and
a driving part adjacent a rear side of the backlight unit, the driving part driving at least one of the display panel or the backlight unit.
